(19) United States
(12) Patent Application Publication
(10) Pub. No.: US 2010/0065245 A1
(43) Pub. Date: Mar. 18, 2010

(54) AIR CONDITIONING SYSTEM

(75) Inventors: Nobuhiro Imada, Osaka (JP); Masamitsu Kitagishi, Osaka (JP)

Correspondence Address: GLOBAL IP COUNSELORS, LLP, 1233 20TH STREET, NW, SUITE 700, WASHINGTON, DC, 20036-2680, US

(73) Assignee: DAIKIN INDUSTRIES, LTD., Osaka-shi, Osaka, JP (JP)

(21) Appl. No.: 12/296,880

(22) PCT Filed: Apr. 16, 2007
(86) PCT No.: PCT/JP2007/058295

§ 371 Date: Oct. 21, 2009

(30) Foreign Application Priority Data
Apr. 17, 2006 (JP) 2006-113094

(51) Int. Cl. F24F 7/007; F25B 13/00; F25B 41/00; F25B 27/00; G05B 15/00

(52) U.S. Cl. 165/59; 165/62; 62/513; 62/238.7; 700/278

(57) ABSTRACT

An An air conditioning system includes an indoor heat exchanger, a fan, a compressor, an outdoor heat exchanger, and a control device. The fan sends air cooled or heated by the indoor heat exchanger and the like to a room in a house via a duct. The compressor is installed outside the house and the capacity thereof can be controlled. The outdoor heat exchanger, together with the indoor heat exchanger and the compressor, forms a heat pump. The control device controls the capacity of the compressor.

### TECHNICAL FIELD

The present invention relates to an air conditioning system. More specifically, the present invention relates to an air conditioning system that cools and heats each room in a house and the like.

### BACKGROUND ART

In recent air conditioning systems in houses and the like, a heat pump is increasingly employed to be added to a heating device that utilizes the fuel combustion energy or to be replaced with such heating device. The heat pump is a device that uses refrigerant and picks up thermal energy of the air (atmosphere) outside the house in order to cool and heat the inside of the house. The heat pump has an advantage of being capable of reducing the energy consumption because the heat pump uses thermal energy of the atmosphere. With the heat pump, the COP (Coefficient of Performance; an index called coefficient of performance or energy consumption efficiency), which is a value obtained by dividing a heating or cooling capacity Q by the energy consumption L required to obtain the capacity Q, often greatly exceeds 1.0.

On the other hand, in the United States, there are many one or two story houses. When the heat pump is installed, often an air conditioning system is employed in which an indoor coil (heat exchanger) of one or at most two heat pumps is installed in the basement or behind the ceiling and conditioned air is supplied from there to each room via a duct. For example, a unit equipped with an indoor coil and a blower motor assembly of a heat pump, as disclosed in Patent Document 1, is installed inside the house and thermal energy of the atmosphere picked up from the air outside the house by the indoor coil and the like is released into supply air to be provided to each room, thereby performing air conditioning in the house.

<Patent Document 1>

JP-A Publication No. H11-316039

### DISCLOSURE OF THE INVENTION

### <Object to be Achieved by the Invention>

However, the conventional air conditioning system in the house in the United States has a system which makes it difficult to perform finely-tuned air-conditioning control.

In addition, in the air conditioning system in which the heat pump and a heating device other than the heat pump are installed in combination, optimal air-conditioning control taking into account the energy conservation and the like is difficult to perform.

In addition, such configuration in which control functions are centralized in an interface unit that allows input of a set temperature for air conditioning in the house is often a factor that impedes flexible and energy conservation-oriented air-conditioning control.

In addition, in the air conditioning system having a function in which the heat pump automatically performs a dehumidifying operation, the timing of the dehumidifying operation and operation method are not necessarily configured in a preferable manner, and it seems that control needs to be further optimized.

In addition, in the United States, there is an air conditioning system in which a set temperature for air conditioning in the house can be set into the schedule, however, there is a case where air-conditioning control according to the schedule is insufficient and a state continues in which the set temperature according to the schedule is not reached.

In addition, a control interface of the air conditioning system installed in the house may not necessarily show sufficient information.

An object of the present invention is to eliminate or reduce each problem described above.

### <Means to Achieve the Object>

An air conditioning system according to a first aspect of the present invention includes a first heat exchanging device, a fan, a compressor, a second heat exchanging device, and a control unit. The first heat exchanging device causes heat exchange between its surrounding air and refrigerant flowing thereinside. The fan sends the air cooled or heated at least by the first heat exchanging device to a plurality of rooms in a house via a duct. The compressor, together with the first heat exchanging device, forms a heat pump. The compressor is a machine whose capacity can be controlled and is installed outside the house. The second heat exchanging device, together with the first heat exchanging device and the compressor, forms the heat pump. The second heat exchanging device is installed outside the house and causes heat exchange between air outside the house and the refrigerant. The control unit controls the capacity of the compressor.

Here, because the capacity controllable compressor is controlled by the control unit, the air conditioning level of conditioned air sent to each room in the house via the duct can be finely adjusted.

Note that the first heat exchanging device may be included in a unit installed inside the house or included in a unit installed outside the house.

An air conditioning system according to a second aspect of the present invention is the air conditioning system according to the first aspect of the present invention, wherein the compressor is a machine that compresses the refrigerant using driving force of an electric motor whose rotation speed is changed by inverter control. Additionally, the control unit controls the inverter for the compressor.

An air conditioning system according to a third aspect of the present invention is the air conditioning system according to the first aspect of the present invention, wherein the first heat exchanging device is constituted by a plurality of heat exchangers. In addition, this air conditioning system further includes a plurality of valves for adjusting the amount of the refrigerant flowing through each of the plurality of heat exchangers. Additionally, the control unit further controls the plurality of valves to adjust the amount of the refrigerant flowing through each of the plurality of heat exchangers.

Here, because the amount of the refrigerant flowing through each of the plurality of heat exchangers can be adjusted, it is possible to send different levels of conditioned air to the plurality of rooms.

An air conditioning system according to a fourth aspect of the present invention is the air conditioning system according to the third aspect of the present invention, further including a damper. This damper is provided to the plurality of heat exchangers and adjusts the amount of air flowing in the surrounding of the heat exchangers. Additionally, the control unit further controls the damper.

Here, it is possible to send different levels of conditioned air to the plurality of rooms, and also the amount of conditioned air sent to the plurality of rooms can be adjusted.

An air conditioning system according to a fifth aspect of the present invention is the air conditioning system according to the third aspect of the present invention, wherein the fan is provided to each of the plurality of heat exchangers.

Here, it is possible to send different levels of conditioned air to the plurality of rooms, and also the amount of conditioned air sent to the plurality of rooms can be adjusted.

An air conditioning system according to a sixth aspect of the present invention is an air conditioning system that supplies conditioned air to a room in a house via a duct, including a heat pump, a heating device other than the heat pump, and a control unit. The heat pump can cool and/or heat air sent to the duct. The heating device can heat air sent to the duct. The control unit adjusts the level of air cooling and/or the level of air heating by the heat pump and the level of air heating by the heating device, according to the operation state of the heat pump.

Here, the air conditioning system is configured to perform adjustment according to the operation state of the heat pump, unlike a conventional air conditioning system that is configured to simply determine whether to activate the heat pump or the heating device based on the outside air temperature and the like. Thus, it is possible to perform adjustment so as to increase the total efficiency. In addition, it is also possible to reduce the cost of the total energy consumption by taking into account the cost of energy consumed by the heat pump and the cost of energy consumed by the heating device as the data.

An air conditioning system according to a seventh aspect of the present invention is the air conditioning system according to the sixth aspect of the present invention, wherein the control unit performs efficiency priority control. In the efficiency priority control, the energy consumption efficiency of the heat pump is compared with the energy consumption efficiency of the heating device in order to adjust the level of air cooling and/or the level of air heating by the heat pump and the level of air heating by the heating device according to the operation state of the heat pump.

An air conditioning system according to an eighth aspect of the present invention is the air conditioning system according to the sixth aspect of the present invention, wherein the control unit performs cost priority control. In the cost priority control, the cost of energy consumed per unit time by the heat pump is compared with the cost of energy consumed per unit time by the heating device in order to adjust the level of air cooling and/or the level of heating by the heat pump and the level of air heating by the heating device according to the operation state of the heat pump.

An air conditioning system according to a ninth aspect of the present invention is the air conditioning system according to the sixth aspect of the present invention, wherein the heating device performs heating by combustion. For example, the heating device is a machine that generates heat by combusting fuel such as oil and gas.

An air conditioning system according to a tenth aspect of the present invention is the air conditioning system according to the sixth aspect of the present invention, wherein the heating device is an electrical heater.

An air conditioning system according to an eleventh aspect of the present invention includes a first heat exchanging device, a compressor, a second heat exchanging device, a heat pump control unit, a control interface, and a system control unit. The first heat exchanging device causes heat exchange between its surrounding air and refrigerant flowing thereinside. The compressor, together with the first heat exchanging device, forms a heat pump. The compressor is a machine whose capacity can be controlled and is installed outside a house. The second heat exchanging device, together with the first heat exchanging device and the compressor, forms the heat pump. The second heat exchanging device is installed outside the house and causes heat exchange between air outside the house and the refrigerant. The heat pump control unit controls the capacity of the compressor. The control interface allows input of a set temperature in the house. The system control unit is directly or indirectly electrically connected to the heat pump control unit and the control interface. The system control unit can perform two-way communication with the heat pump control unit and issues a command to at least a device other than the heat pump.

Here, the configuration is employed in which the system control unit different from the control interface is provided and two-way communication is performed between the system control unit and the heat pump control unit, unlike a conventional air conditioning system in which the control interface is equipped with a control function for the entire air conditioning system. Thus, the system control unit can obtain data concerning the operation state and the like of the heat pump and perform various types of finely-tuned control with respect to the device and the like other than the heat pump of the air conditioning system.

An air conditioning system according to a twelfth aspect of the present invention is the air conditioning system according to the eleventh aspect of the present invention, wherein the device other than the heat pump is at least one of the followings: a heating device that performs heating by combustion, an electrical heater, a fan that sends conditioned air to a plurality of rooms in a house, a humidifier, a total heat exchanger, and a sensible heat exchanger.

An air conditioning system according to a thirteenth aspect of the present invention is the air conditioning system according to the eleventh aspect of the present invention, wherein the system control unit issues a command to the device other than the heat pump and the heat pump.

An air conditioning system according to a fourteenth aspect of the present invention includes a set temperature scheduling unit, an air conditioning unit, and a control unit. The set temperature scheduling unit can change a set temperature for air conditioning in a house for each period and/or day. The air conditioning unit performs air conditioning in the house using energy. During a predetermined period and/or day within the periods and/or days demarcated by the set temperature scheduling unit, the control unit controls the air conditioning unit giving priority to the set temperature; whereas when outside the predetermined period and/or day, the control unit controls the air conditioning unit giving priority not to the set temperature but to keeping the energy consumption per unit time below a predetermined upper limit.

Here, the user can select that the so-called demand control be performed during a predetermined period and/or day and that the demand control be not performed outside the predetermined period and/or day. The demand control is control in which the amount of energy consumed by the air conditioning system is monitored on real time basis and the level of air conditioning by the air conditioning unit is controlled such that the amount of energy consumption per predetermined unit time does not exceed the upper limit.

An air conditioning system according to a fifteenth aspect of the present invention is the air conditioning system according to the fourteenth aspect of the present invention, wherein the predetermined period and/or day is a period during weekdays when a person is usually not home and/or a period when a person is usually asleep.

Here, because the demand control is performed during when the discomfort does not increase so much even if the demand control is performed, it is possible to maintain inside the house to be a comfortable space for the user while facilitating energy conservation and a reduction in the cost of energy consumed by the air conditioning system.

An air conditioning system according to a sixteenth aspect of the present invention is an air conditioning system that supplies conditioned air to a room in a house via a duct, and includes a heat pump, a fan, a control interface, and a control unit. The heat pump can cool and/or heat air sent to the duct. The fan sends the conditioned air cooled or heated by the heat pump to the room in the house via the duct. The control interface allows input of an instruction with respect to a dehumidifying operation. When the instruction with respect to the dehumidifying operation is input to the control interface, the control unit performs dehumidification control in which conditioned air is dehumidified by controlling the heat pump and/or the fan.

Conventionally, the dehumidifying operation is automatically performed when it is determined to be highly humid based on a detection result by a humidity sensor and the like. However, here, because the dehumidification control is performed when an instruction with respect to the dehumidifying operation is input to the control interface, an improper reduction in the comfort level of the user in the house is prevented.

An air conditioning system according to a seventeenth aspect of the present invention is an air conditioning system that supplies conditioned air to a room in a house via a duct, and includes a heat pump, a fan, an outside air temperature sensor, and a control unit. The heat pump can cool and/or heat air sent to the duct. The fan sends the conditioned air cooled or heated by the heat pump to the room in the house via the duct. The outside air temperature sensor measures an outside air temperature outside the house. The control unit periodically performs periodic dehumidification control in which the conditioned air is dehumidified by controlling the heat pump and/or the fan when the outside air temperature measured by the outside air temperature sensor falls below a predetermined value.

Here, because dehumidification is periodically performed when the outside air temperature drops, dehumidification can be efficiently performed. Note that this periodic dehumidification control is especially useful in hot and humid areas.

An air conditioning system according to an eighteenth aspect of the present invention is an air conditioning system that supplies conditioned air to a room in a house via a duct, and includes a heat pump, a fan, and a dehumidification control unit. The heat pump has a capacity controllable compressor and can cool and/or heat air sent to the duct. The fan sends the conditioned air cooled or heated by the heat pump to the room in the house via the duct. The air volume of the fan can be adjusted. The dehumidification control unit decreases the air volume of the fan and increases the capacity of the compressor during a dehumidifying operation.

Here, during the dehumidifying operation, the air volume of the fan is decreased and the capacity of the compressor is increased, so that it is possible to ensure the amount of dehumidification while preventing the user in the house from feeling discomfort because of a sudden drop in the temperature.

An air conditioning system according to a nineteenth aspect of the present invention is an air conditioning system that supplies conditioned air to a room in a house, and includes a heat pump, a control interface, a control unit, and a learning and improving unit. The heat pump has a capacity controllable compressor and can cool and/or heat air sent to the room in the house. The control interface allows input of a set temperature to be reached at a predetermined time in the room in the house. The control unit performs preliminary control in which a target air conditioning temperature is changed to the set temperature prior to the predetermined time such that the set temperature is reached in the room in the house at the predetermined time. The learning and improving unit adjusts start time at which the target air conditioning temperature is changed to the set temperature in the next the preliminary control according to the state of the preliminary control in the past.

Here, according to the state of the preliminary control in the past, the start time at which the target air conditioning temperature is changed to the set temperature ahead of schedule and prior to a predetermined time is determined. Thus, it can be expected that the temperature in the house changes to the set temperature without delaying from the fixed, predetermined time, compared to a conventional air conditioning system in which the start time is uniformly determined based only on the difference between the current temperature and the set temperature at the predetermined time.

An air conditioning system according to a twentieth aspect of the present invention is the air conditioning system according to the nineteenth aspect of the present invention, further including a heating device other than the heat pump. This heating device can heat air sent to the room in the house. Additionally, in the preliminary control, the control unit issues a command to the heating device in addition to the heat pump.

An air conditioning system according to a twenty-first aspect of the present invention is the air conditioning system according to the nineteenth aspect of the present invention, further including an outside air temperature sensor that measures an outside air temperature outside the house. Additionally, the learning and improving unit adjusts the start time based on the outside air temperature.

An air conditioning system according to a twenty-second aspect of the present invention is an air conditioning system that supplies conditioned air to a room in a house via a duct, and includes a first heat exchanging device, a compressor, a second heat exchanging device, a heat pump control unit, an outside air temperature sensor, and a control interface. The first heat exchanging device causes heat exchange between its surrounding air and refrigerant flowing thereinside. The compressor, together with the first heat exchanging device, forms a heat pump. The compressor is installed outside the house and the capacity thereof can be controlled. The second heat exchanging device, together with the first heat exchanging device and the compressor, forms the heat pump. The second heat exchanging device is installed outside the house and causes heat exchange between air outside the house and the refrigerant. The heat pump control unit controls the capacity of the compressor. The outside air temperature sensor measures an outside air temperature outside the house and sends the result to the heat pump control unit. The control interface is directly or indirectly connected to the heat pump control unit. The control interface has an input unit that allows input of a set temperature in the house, and a display unit that displays the outside air temperature.

Here, because the measured outside air temperature is displayed on the display unit of the control interface, in the case such as when the current temperature is slightly inconsistent with the set temperature, the user can judge whether or not it is affected by the outside air temperature.

An air conditioning system according to a twenty-third aspect of the present invention is an air conditioning system that supplies conditioned air to a room in a house via a duct, and includes a heat pump, a control interface, a heat pump control unit, a fault detection unit, a contact information storage unit, and a contact information display unit. The heat pump can cool and/or heat air sent to the duct. The control interface has a display device. The control interface further either has an inputting device that allows input of a set temperature in the house or is capable of connecting thereto the inputting device that allows input of a set temperature in the house. The heat pump control unit controls the heat pump based on the set temperature. The fault detection unit detects a fault in the heat pump. The contact information storage unit stores contact information in case of a failure of the heat pump. The contact information display unit displays the contact information stored in the contact information storage unit on the display device of the control interface when a failure of the heat pump is detected by the fault detection unit.

Here, when a failure occurs in the heat pump, the contact information is displayed on the display device of the control interface. Thus, the user can save the labor of searching for the contact information and can also contact the contact information that is definitely correct.

An air conditioning system according to a twenty-fourth aspect of the present invention is the air conditioning system according to the twenty-third aspect of the present invention, wherein the inputting device is any one of the followings: a computer having an input function connected to the control interface, an input-only device connected to the control interface, and a read-out device of a recording medium incorporated in the control interface or in the device connected to the control interface.

An air conditioning system according to a twenty-fifth aspect of the present invention is the air conditioning system according the twenty-fourth aspect of the present invention, further including a set temperature scheduling unit. The set temperature scheduling unit is incorporated in or connected to the control interface. The set temperature scheduling unit can change a set temperature for air conditioning in a house for each period and/or day.

In addition, the inputting device allows input for setting the set temperature for each period and/or day.

### <Effects of the Invention>

In the air conditioning system according to the first through fifth aspects of the present invention, finely-tuned air-conditioning control can be easily performed.

In the air conditioning system according to the sixth through tenth aspects of the present invention, the level of air cooling and/or the level of air heating by the heat pump and the level of air heating by the heating device are adjusted according to the operation state of the heat pump, so that it is possible to perform adjustment so as to increase the total efficiency of the air conditioning system and to reduce the cost of the total energy consumption.

In the air conditioning system according to the eleventh through thirteenth aspects of the present invention, the configuration is employed in which the system control unit different from the control interface is provided and two-way communication is performed between the system control unit and the heat pump control unit, so that the system control unit can perform various types of finely-tuned control with respect to the device other than the heat pump of the air conditioning system by obtaining data concerning the operation state and the like of the heat pump.

In the air conditioning system according to the fourteenth and fifteenth aspects of the present invention, the user can select that the so-called demand control be performed during a predetermined period and/or day and that the demand control be not performed outside the predetermined period and/or day, thus energy conservation and cost reduction can be easily facilitated.

In the air conditioning system according to the sixteenth aspect of the present invention, an improper reduction in the comfort level of the user in the house is prevented.

In the air conditioning system according to the seventeenth aspect of the present invention, dehumidification can be efficiently performed.

In the air conditioning system according to the eighteenth aspect of the present invention, it is possible to ensure the amount of dehumidification while preventing the user from feeling discomfort because of a sudden drop in the temperature.

In the air conditioning system according to the nineteenth through twenty-first aspects of the present invention, it can be expected that the temperature in the house changes to the set temperature without delaying from the fixed, predetermined time.

In the air conditioning system according to the twenty-second aspect of the present invention, in the case such as when the current temperature is slightly is inconsistent with the set temperature, the user can judge whether or not it is affected by the outside air temperature.

In the air conditioning system according to the twenty-third through twenty-fifth aspects of the present invention, the user can save the labor of searching for the contact information and can also contact the contact information that is definitely correct when a failure occurs in the heat pump.

### BRIEF DESCRIPTION OF THE DRAWINGS

FIG. 1 is a layout diagram of an air conditioning system according to a first embodiment.

FIG. 2 is a schematic configuration diagram of the air conditioning system according to the first embodiment.

FIG. 3 is a view showing an assembly of each indoor unit of the air conditioning system according to the first embodiment.

FIG. 4 is a control block diagram of the air conditioning system according to the first embodiment.

FIG. 5 is a view showing an alternative embodiment of the air conditioning system according to the first embodiment.

FIG. 6 is a layout diagram of an air conditioning system according to a second embodiment.

FIG. 7 is a schematic configuration diagram of the air conditioning system according to the second embodiment.

FIG. 8 is a control block diagram of the air conditioning system according to the second embodiment.

FIG. 9 is a view showing an example of a schedule of a day of the air conditioning system according to the second embodiment.

FIG. 10 is a view showing a schedule setting screen of the air conditioning system according to the second embodiment.

FIG. 11 is a view showing a demand control allowability setting screen of the air conditioning system according to the second embodiment.

FIG. 12 is a preliminary control flow based on a schedule of the air conditioning system according to the second embodiment.

FIG. 13 is a dehumidifying operation flow of the air conditioning system according to the second embodiment.

FIG. 14 is a view showing one screen of a control interface of the air conditioning system according to the second embodiment.

FIG. 15 is a view showing one screen of the control interface of the air conditioning system according to the second embodiment.

FIG. 16 is a view showing one screen of the control interface of the air conditioning system according to the second embodiment.

FIG. 17 is a view showing one screen of the control interface of the air conditioning system according to the second embodiment.

FIG. 18 is a view showing one screen of the control interface of the air conditioning system according to the second embodiment.

FIG. 19 is a view showing one screen of the control interface of the air conditioning system according to the second embodiment.

FIG. 20 is a view showing one screen of the control interface of the air conditioning system according to the second embodiment.

### DESCRIPTION OF THE REFERENCE SYMBOLS

10 Control device
11 Control interface
12 Main controller
13 Outdoor unit controller
21 Outdoor heat exchanger
22 Compressor
32 Indoor heat exchanger
38 Fan
42 Indoor heat exchanger
48 Fan
81 Display
82 to 85 Input keys
95 Damper
110 Control device
111 Control interface
112 Main controller
112a Memory
112b Scheduling unit
113 Outdoor unit controller
113b Fault detection unit
121 Outdoor heat exchanger
122 Compressor
127 Outside air temperature sensor
132 Indoor heat exchanger
136 Gas furnace
138 Fan
151 Supply duct

### BEST MODE FOR CARRYING OUT THE INVENTION

### FIRST EMBODIMENT

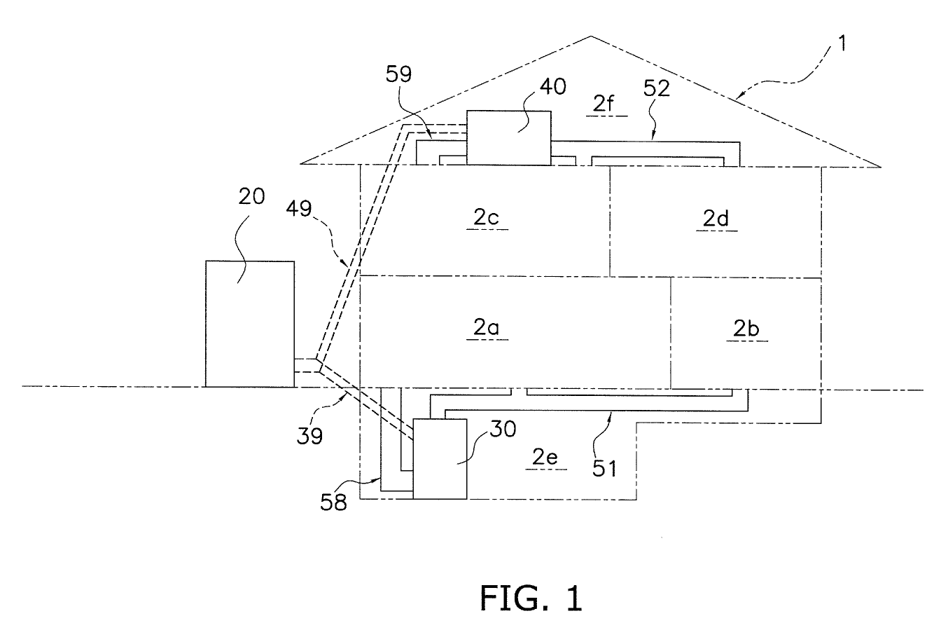

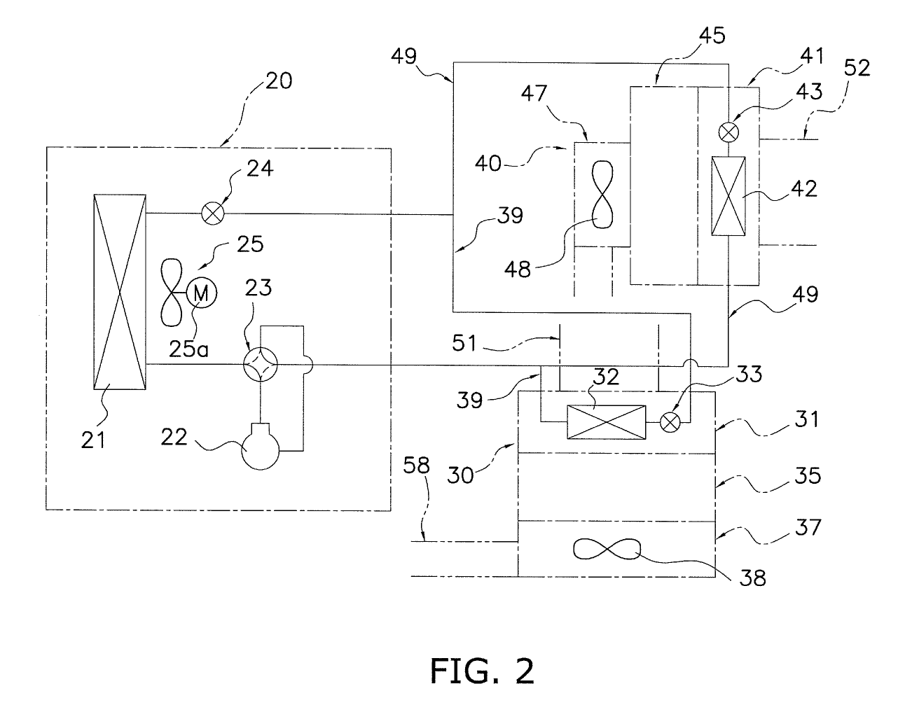

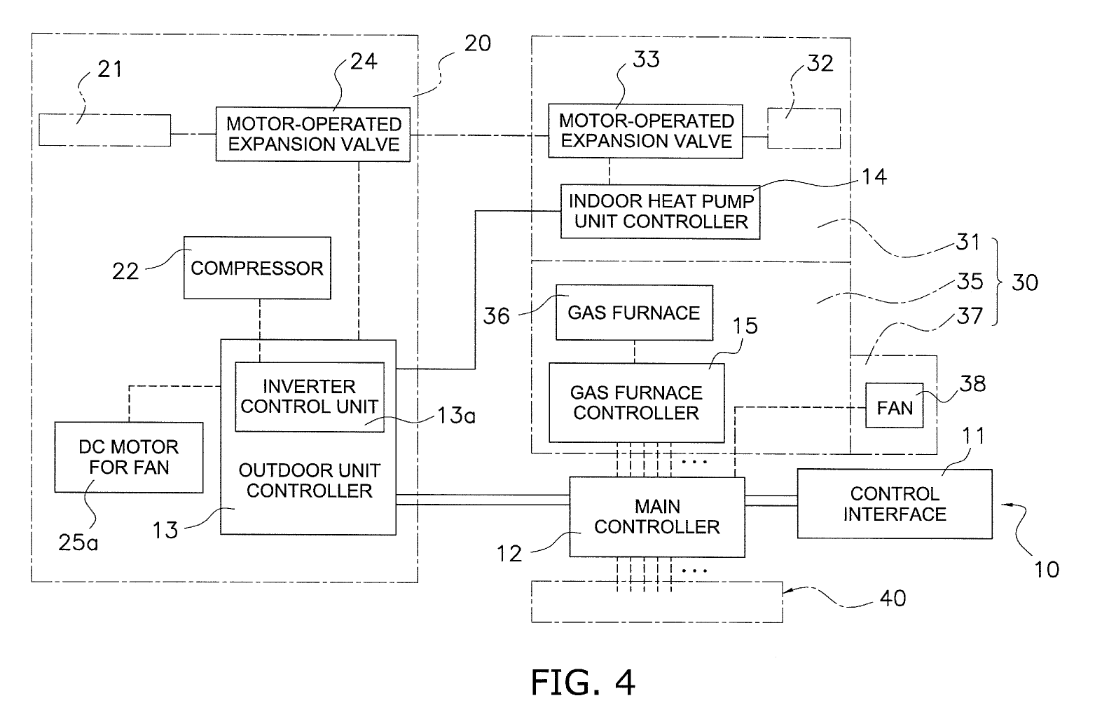

An air conditioning system according to a first embodiment of the present invention is shown in FIGS. 1, 2, and 4. This air conditioning system is an air conditioning system applicable to a one story or a low-rise building 1 such as a house or the like, and mainly includes a heat pump constituted by an outdoor heat pump unit 20 and indoor heat pump units 31 and 41, gas furnace units 35 and 45, and fan units 37 and 47. As described later, the indoor heat pump unit 31, the gas furnace unit 35, and the fan unit 37 are integrated in a basement 2e of the building 1 and form an indoor unit 30. Similarly, the indoor heat pump unit 41, the gas furnace unit 45, and the fan unit 47 are integrated in a behind-the-ceiling space 2f of the building 1 and form an indoor unit 40. These integrations are described in detail later.

A supply duct 51 carries conditioned air from the indoor unit 30 installed in the basement 2e to rooms 2a and 2b on the first floor. On the other hand, return air from the rooms 2a and 2b is returned to the indoor unit 30 through a return air duct 58 that interconnects the room 2a and the indoor unit 30. In addition, a supply duct 52 carries conditioned air from the indoor unit 40 installed in the behind-the-ceiling space 2f to the rooms 2c and 2d on the second floor. Return air from the rooms 2c and 2d is returned to the indoor unit 40 through a return air duct 59 that interconnects the room 2c and the indoor unit 40.

<Structure of the Heat Pump>

The heat pump is a machine in which two indoor heat pump units 31 and 41 are provided to one outdoor heat pump unit 20. With the heat pump, the cooling and heating capacities of each of the indoor heat pump units 31 and 41 can be changed as a result of adjustment of the capacity of a compressor 22 of the outdoor heat pump unit 20 by inverter control and adjustment of the opening degrees of indoor motor-operated expansion valves 33 and 43 in the indoor heat pump units 31 and 41. With the heat pump, two refrigerant communication pipes for liquid refrigerant and gas refrigerant extending from one outdoor heat pump unit 20 are branched midway, one becoming a refrigerant communication pipe 39 and the other becoming a refrigerant communication pipe 59 to be connected to the indoor heat pump units 31 and 41, respectively.

The heat pump drives the compressor 22 using electrical energy and circulates the refrigerant in a refrigerant circuit to remove heat from the air outside the building 1 to supply the heat into the building 1, and to remove heat from the air inside the building 1 to release the heat to the outside of the building 1. Accordingly, the heat pump cools and heats air sent out to the supply ducts 51 and 52 by fans 38 and 48 (described later).

The refrigerant circuit of the heat pump includes the compressor 22, a four way valve 23, an outdoor heat exchanger 21, an outdoor motor-operated expansion valve 24, indoor heat exchangers 32 and 42, and the indoor motor-operated expansion valves 33 and 43. In addition, the heat pump includes an outdoor fan 25, an outdoor unit controller 13, an indoor heat pump unit controller 14, and the like, besides the devices that constitute the refrigerant circuit.

The compressor 22, the four way valve 23, the outdoor heat exchanger 21, the outdoor motor-operated expansion valve 24, the outdoor fan 25, and the outdoor unit controller 13 are housed in the outdoor heat pump unit 20. The indoor heat exchangers 32 and 42, the indoor motor-operated expansion valves 33 and 43, and the indoor heat pump unit controller 14 are housed in the indoor heat pump units 31 and 41.

The outdoor heat exchanger 21 causes heat exchange between outside air blown thereto by the outdoor fan 25 and the refrigerant flowing thereinside. The compressor 22 is a machine whose capacity can be adjusted by controlling the inverter for a driving motor by an inverter control unit 13a. The compressor 22 sucks low pressure gas refrigerant, compresses it, and discharges it as high pressure gas refrigerant.

In addition, numbers of temperature sensors including an outside air temperature sensor and pressure sensors are connected to the outdoor unit controller 13, and state values of each portion of the heat pump are collected in the outdoor unit controller 13.

The indoor heat pump units 31 and 41 have the same configurations although they are installed at different places with different orientations. Thus, here, a description is given taking the indoor heat pump unit 31 as an example.

The indoor heat pump unit 31 flows the refrigerant sent from the outdoor heat pump unit 20 to an indoor heat exchanger 32 while adjusting the flow rate of the refrigerant by the indoor motor-operated expansion valve 33, and causes heat exchange between the air sent from the fan 38 (described late) and the refrigerant flowing through the indoor heat exchanger 32. For example, during a period when cooling is needed only in the rooms 2a and 2b on the first floor and air conditioning is not needed in the rooms 2c and 2d on the second floor, the outdoor unit controller 13 issues a command to the indoor heat pump unit controller 14 to widely open the indoor motor-operated expansion valve 33 of the indoor heat pump unit 31 and to close the indoor motor-operated expansion valve 43 of the indoor heat pump unit 41, and the inverter for the compressor 22 of the outdoor heat pump unit 20 is controlled in accordance with the air conditioning load of the rooms 2a and 2b.

<Structure of the Gas Furnace Unit>

The gas furnace units 35 and 45 combust gaseous fuel and heat the air sent out to the supply ducts 51 and 52 by the fans 38 and 48 (described later). The gas furnace units 35 and 45 mainly include gas furnaces 36 and 46 that combust gas and gas furnace controllers 15 and 15 that control the amount of combustion.

<Structure of the Fan Unit>

The fan units 37 and 47 serve a function to suck indoor air from the return air ducts 58 and 59 and to send out the air to the supply ducts 51 and 52 by the fans 38 and 48 such as a sirocco fan and the like. Here, the air volume of the fans 38 and 48 can be adjusted based on a command from a main controller 12 (described later).

<Structure of the Control Device of the Air Conditioning System>

The core components of a control device 10 of the air conditioning system are: a control interface 11 that allows the user to input a set temperature and the like and that also provides the user with the necessary information, and the main controller 12 that adjusts and controls the entire air conditioning system. The outdoor unit controller 13 of the heat pump, the gas furnace controller 15 of the gas furnace unit 35, and the fan 38 of the fan unit 37 are electrically connected to the main controller 12 in a communicable manner. The indoor heat pump unit controller 14 of the heat pump is connected to the main controller 12 via the outdoor unit controller 13.

The main controller 12 is connected such that it can perform two-way communication with the outdoor unit controller 13. Further, according to the operation state of the heat pump, the main controller 12 adjusts the levels of cooling and heating by each of the indoor heat pump units 31 and 41 of the heat pump, and the level of heating by the gas furnace units 35 and 45.

The control interface 11 is disposed with a display for displaying various information, and input keys for allowing the user to input a set temperature for air conditioning in the building 1.

<Integration of the Indoor Heat Pump Unit, the Gas Furnace Unit, and the Fan Unit>

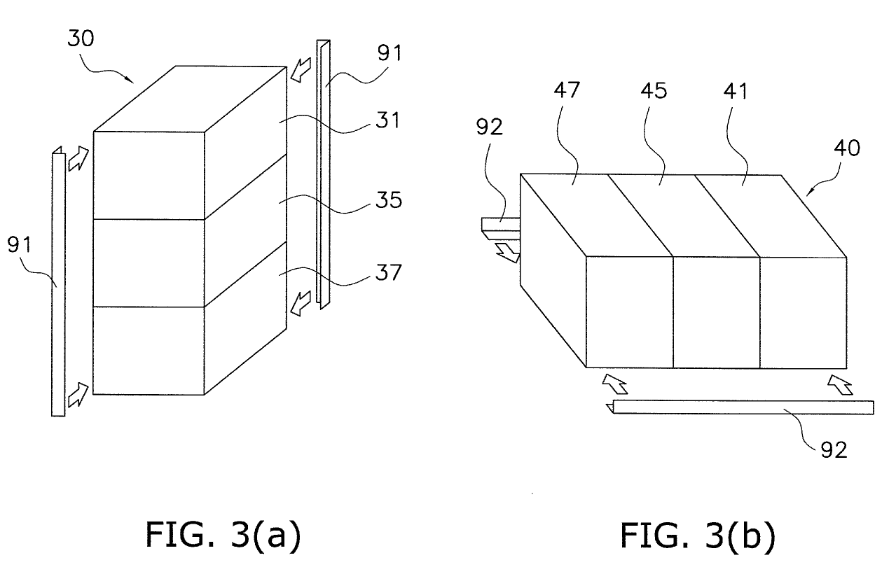

FIG. 3(a) shows the indoor unit 30 including the indoor heat pump unit 31, the gas furnace unit 35, and the fan unit 37, and FIG. 3(b) shows the indoor unit 40 including the indoor heat pump unit 41, the gas furnace unit 45, and the fan unit 47.

First, the indoor unit 30 is constituted by the integration of the indoor heat pump unit 31, the gas furnace unit 35, and the fan unit 37 in the basement 2e. Each of the units 31, 35, and 37 has the same quadrangular shape when seen from the top, and they are vertically stacked. Four stays (only two are shown in FIG. 91 are provided at the four corners and secured to each of the units 31, 35, and 37 by a screw and the like. Thereby these three units 31, 35, and 37 are integrated together.

Next, the indoor unit 40 is constituted by the integration of the indoor heat pump unit 41, the gas furnace unit 45, and the fan unit 47 in the behind-the-ceiling space 2f. Each of the units 41, 45, and 47 has the same quadrangular shape when seen from the side, and they are horizontally aligned. Four stays (only two are shown in FIG. 92 are provided at the four corners and secured to each of the units 41, 45, and 47 by a screw and the like. Thereby these three units 41, 45, and 47 are integrated together.

Note that the indoor unit 30 installed in the basement 2e is often placed on the floor surface; whereas the indoor unit 40 installed in the behind-the-ceiling space 2f is sometimes suspended from the beams of the roof with the stays 92. In addition, when the indoor unit 40 is suspended from the beams of the roof in the behind-the-ceiling space 2f, a drain pan disposed below the indoor unit 40 can be suspended from the stays 92.

<CHARACTERISTICS OF THE AIR CONDITIONING SYSTEM ACCORDING TO THE FIRST EMBODIMENT>

(1)

In the air conditioning system according to the first embodiment, the configuration is employed in which the main controller 12 different from the control interface 11 is provided and two-way communication is performed between the main controller 12 and the outdoor unit controller 13 of the heat pump control unit, unlike a conventional air conditioning system in which the control interface is equipped with a control function for the entire air conditioning system. Therefore, the main controller 12 can obtain data concerning the operation state and the like of the heat pump and perform various types of finely-tuned control with respect to the heat pump and the gas furnace 36.

In particular, because this air conditioning system is provided with the heat pump having the capacity controllable compressor 22 and capable of adjusting the levels of cooling and heating by each of the indoor heat pump units 31 and 41 by controlling the capacity of the compressor 22 by the inverter control unit 13a and by controlling each of the indoor motor-operated expansion valves 33 and 43, the configuration of having the main controller 12 different from the control interface 11 is found to be very advantageous in the air conditioning system.

(2)

In the air conditioning system according to the first embodiment, the amount of the refrigerant flowing through the indoor heat exchanger 32 of the indoor heat pump unit 31 and the amount of the refrigerant flowing through the indoor heat exchanger 42 of the indoor heat pump unit 41 are adjusted by adjusting the opening degrees of the indoor motor-operated expansion valves 33 and 43, respectively. Thus, it is possible to send different levels of conditioned air to the rooms 2a and 2b on the first floor and the rooms 2c and 2d on the second floor.

(3)

In the air conditioning system according to the first embodiment, the stays 91 are used to integrate the three units 31, 35, and 37, and also the stays 92 are used to integrate the three units 41, 45, and 47. Thus, the probability of the occurrence of construction error will be lower and a problem such as vibration of the supply ducts 51 and 52 and the return air ducts 58 and 59 will be reduced, compared to a conventional type in which those units are integrated by putty or taping.

### ALTERNATIVE EMBODIMENT OF THE FIRST EMBODIMENT

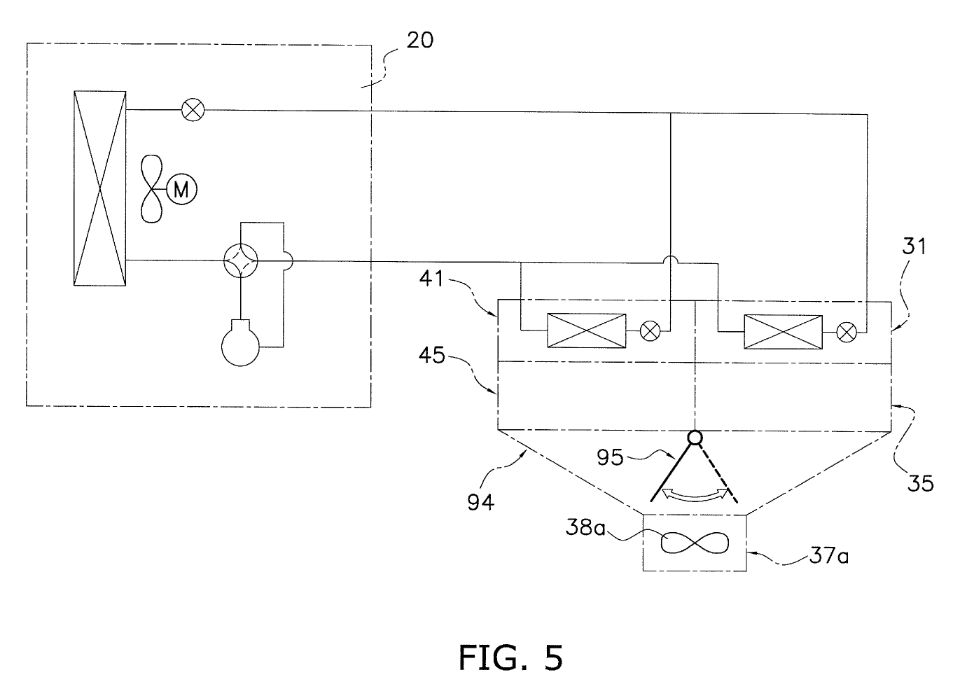

In the air conditioning system according to the above described first embodiment, the indoor heat pump unit 31 is disposed in the basement 2e, and the indoor heat pump unit 41 is disposed in the behind-the-ceiling space 2f, however, as shown in FIG. 5, both of the units 31 and 41 can be put together as one. Additionally, in a configuration in which both of the units 31 and 41 share the single fan unit 37a, the air sent out from the fan 38a of the fan unit 37a may be divided by a damper 95 of a damper unit 94 so as to flow into both of the units 31 and 41. In this case, the main controller 12 controls the damper 95 in addition to the indoor motor-operated expansion valves 33 and 43 of both the units 31 and 41, and adjusts the amount and temperature of conditioned air supplied to each of the rooms 2a, 2b, 2c, and 2d.

### SECOND EMBODIMENT

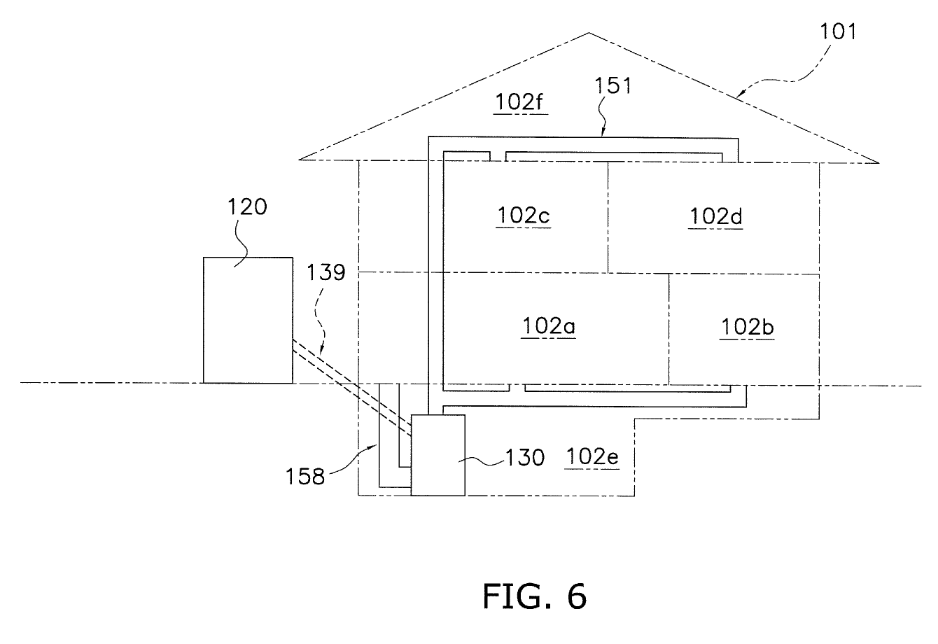

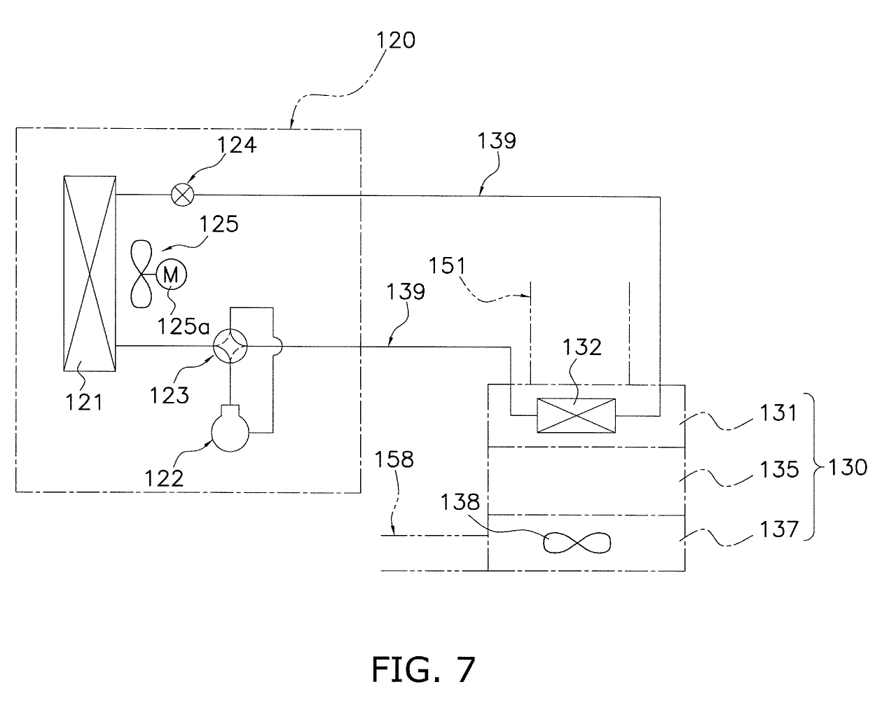

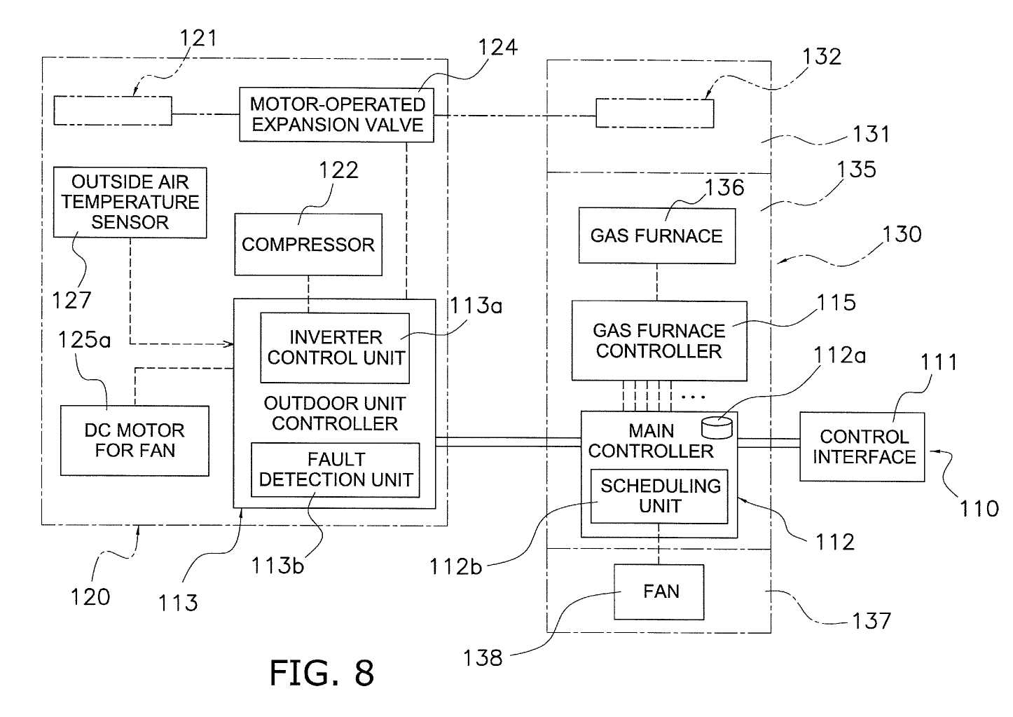

An air conditioning system according to a second embodiment of the present invention is shown in FIGS. 6 to 8. This air conditioning system is an air conditioning system applicable to a one story or a low-rise building 101 such as a building and the like, and mainly includes a heat pump constituted by an outdoor heat pump unit 120 and an indoor heat pump unit 131, a gas furnace unit 135, and a fan unit 137. The indoor heat pump unit 131, the gas furnace unit 135, and the fan unit 137 are integrated in a basement 102e of the building 101 and form an indoor unit 130. Such integration is same as the integration of the indoor heat pump unit 31, the gas furnace unit 35, and the fan unit 37 in the above described first embodiment, so that a description thereof is omitted there.

A supply duct 151 carries conditioned air from the indoor unit 130 to each of rooms 102a through 102d. On the other hand, return air from each of the rooms 102a through 102d is returned to the indoor unit 130 through a return air duct 158 that interconnects the room 102a and the indoor unit 130.

Note that, here, the indoor unit 130 is installed in the basement 102e, but the indoor unit can be installed in a behind-the-ceiling space 102f.

<Structure of the Heat Pump>

The heat pump drives a compressor 122 using electrical energy and circulates the refrigerant in the refrigerant circuit to remove heat from the air outside the building 101 to supply the heat into the building 101 and to remove heat from the air inside the building 101 to release the heat to the outside of the building 101. Accordingly, the heat pump cools and heats the air sent out to a supply duct 151 by a fan 138 (described later). The heat pump includes the compressor 122, a four way valve 123, an outdoor heat exchanger 121, an outdoor motor-operated expansion valve 124, and an indoor heat exchanger 132, which constitute a refrigerant circuit. In addition, the heat pump includes an outdoor fan 125 and the outdoor unit controller 113 besides the devices that constitute the refrigerant circuit. The outdoor unit controller 113 controls the compressor 122, the outdoor fan 125, and the outdoor motor-operated expansion valve 124.

The compressor 122, the four way valve 123, the outdoor heat exchanger 121, the outdoor motor-operated expansion valve 124, the outdoor fan 125 and the outdoor unit controller 113 are housed in the outdoor heat pump unit 120. The indoor heat exchanger 132 is housed in a casing of the indoor heat pump unit 131. A refrigerant communication pipe 139 connects between the four way valve 123 and the indoor heat exchanger 132 and between the outdoor motor-operated expansion valve 124 and the indoor heat exchanger 132. In addition, the heat pump is provided with an accumulator and other auxiliary equipment, however, drawings and descriptions there of are omitted here.

The indoor heat exchanger 132 causes heat exchange between the air sent from a fan 128 (described later) and the refrigerant flowing thereinside. The outdoor heat exchanger 121 causes heat exchanged between outside air blown thereto by the outdoor fan 125 and the refrigerant flowing thereinside. The compressor 122 is a machine whose capacity can be adjusted by controlling an inverter for a driving motor by an inverter control unit 113a. The compressor 122 sucks low pressure gas refrigerant, compresses it, and discharges it as high pressure gas refrigerant.

Numbers of temperature sensors including an outside air temperature sensor 127 and pressure sensors are connected to the outdoor unit controller 113, and state values of each portion of the heat pump are collected in the outdoor unit controller 113. The outside air temperature sensor 127 measures the outside air temperature of air (outside air) outside the building 101.

<Structure of the Gas Furnace Unit>

The gas furnace unit 135 combusts gaseous fuel and heats the air sent out to the supply duct 151 by the fan 138 (described later). The gas furnace unit 135 mainly include a gas furnace 136 that combusts gas and a gas furnace controller 115 that controls the amount of combustion.

<Structure of the Fan Unit>

The fan unit 137 serves a function to suck indoor air from the return air duct 158 and to send out the air to the supply duct 151 by the fan 138 such as a sirocco fan and the like. Here, the air volume of the fan 138 can be adjusted based on a command from a main controller 112 (described later).

<Structure of the Control Device of the Air Conditioning System>

The core components of a control device 110 of the air conditioning system are: a control interface 111 that allows the user to input a set temperature and the like and that also provides the user with the necessary information, and the main controller 112 that adjusts and controls the entire air conditioning system. The outdoor unit controller 113 of the heat pump, the gas furnace controller 115 of the gas furnace unit 135, and the fan 138 of the fan unit 137 are electrically connected to the main controller 112 in a communicable manner.

The main controller 112 is connected such that it can perform two-way communication with the outdoor unit controller 113. Further, according to the operation state of the heat pump, the main controller 112 adjusts the levels of cooling and heating by the heat pump and the level of heating by the gas furnace unit 135. Specifically, the main controller 112 performs efficiency priority control. In the efficiency priority control, the electrical energy consumption efficiency of the heat pump is compared with the gas energy consumption efficiency of the gas furnace 136 in order to adjust the capacity of the compressor 122 and the combustion level of the gas furnace 136 according to the operation state of the heat pump such that the total energy consumption efficiency is improved, and commands are issued to the outdoor unit controller 113 and the gas furnace controller 115.

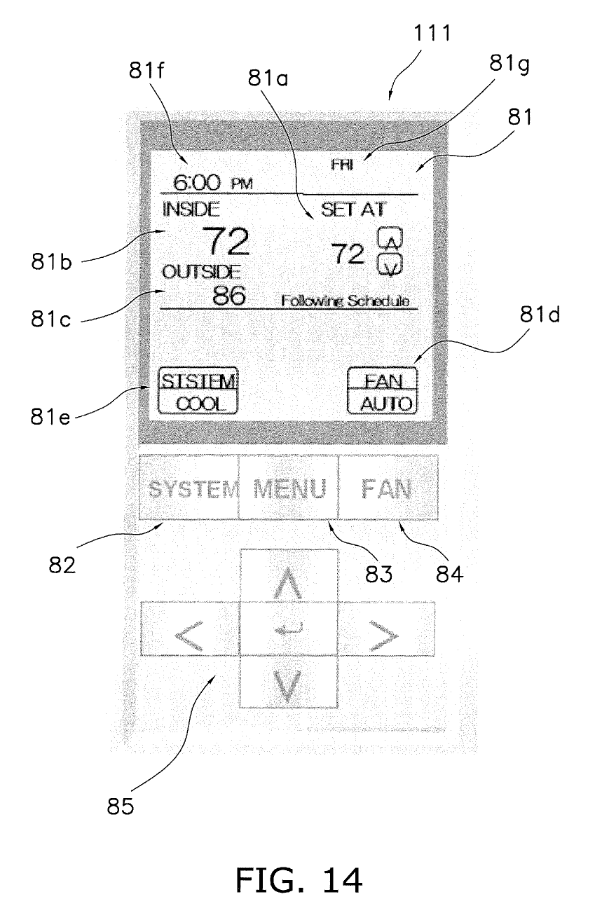

The control interface 111 is disposed with a display 81 for displaying various types of information, and input keys 82 to 85 for allowing the user to input a set temperature for air conditioning in the building 101. As shown in FIG. 14, during a normal operation, the display 81 shows: information 81a indicative of the current air conditioning set temperature (here, 72 degrees F.); information 81b indicative of the current actual temperature in the building 101 (here, 72 degrees F.); information 81c indicative of the current outside air temperature (here, 86 degrees F.); information 81d indicative of the current setting of the air volume of the fan 138 (here, automatic); information 81e indicative of the current air conditioning system mode (here, cooling); information 81f indicative of the current time (here, 6:00 p.m.), information 81g indicative of today's day of the week (here, Friday), and the like. For example, the information 81c indicative of the current outside air temperature is provided by the main controller 112 that constantly receives information on the outside air temperature from the outdoor unit controller 113.

<Schedule Setting for Air Conditioning Set Temperature>

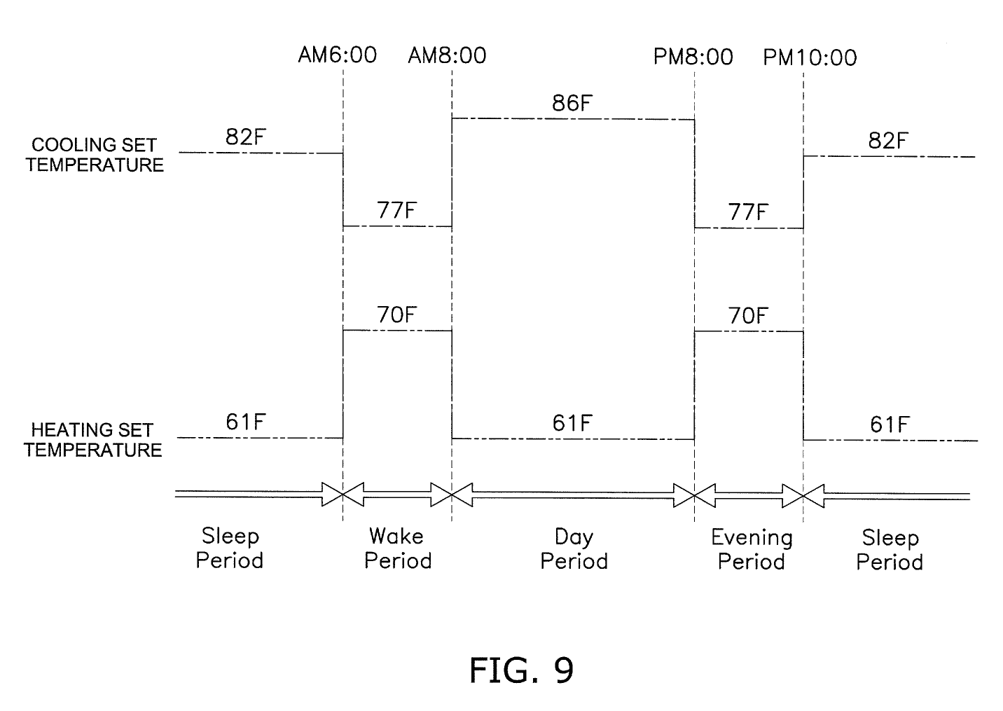

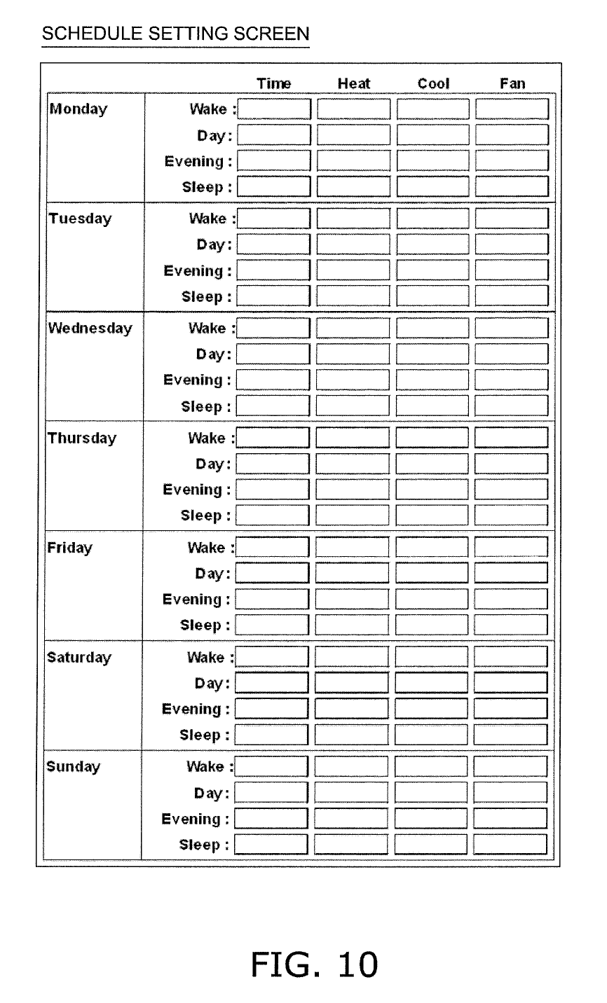

Schedule setting for air conditioning set temperature is described with reference to FIGS. 9 and 10.

The main controller 112 is provided with a scheduling unit (schedule program) 112b, and has a function to activate the heat pump, the gas furnace 136, and the fan 138 according to schedule information stored in a memory 112a.

First, setting schedule information is described.

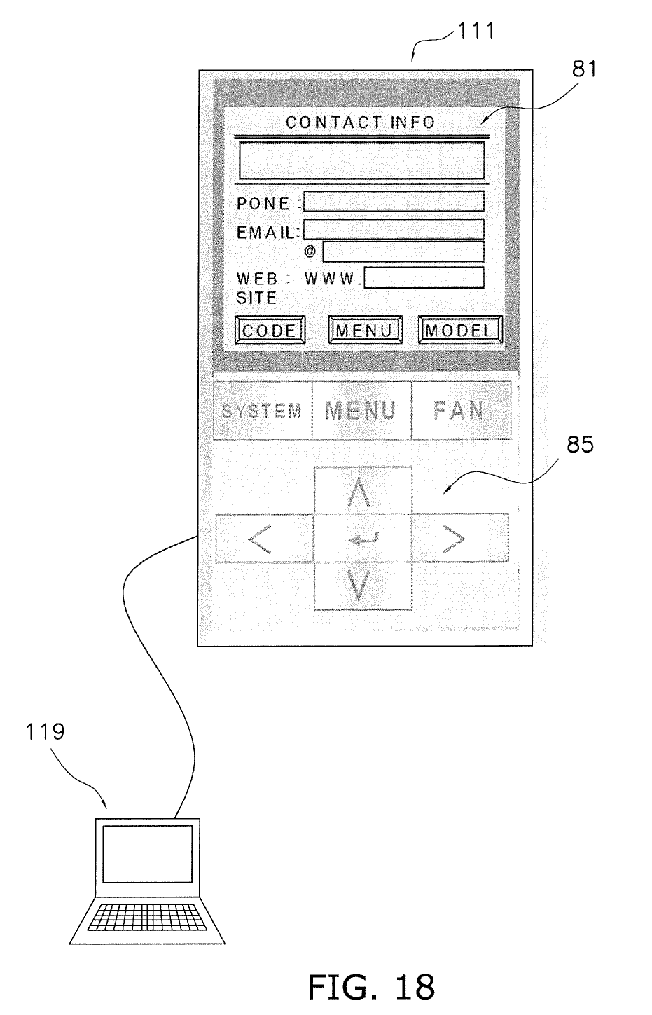

The control interface 111 has a function to allow input of set temperatures for cooling and heating of air conditioning in the building 101 and an air volume of the fan unit 137 for each block of days of the week and periods. Information (schedule information) input through the control interface 111 is sent to the scheduling unit 112b of the main controller 112 and stored in the memory 112a. When the input key 83 that says “MENU” among the input keys 82 to 85 of the control interface 111 shown in FIG. 14 is pressed and an item that says “SCHEDULE SET” is selected using the input key 85 for operation, a schedule setting screen as shown in FIG. 10 appears on the display 81. Here, for each day from Monday to Friday, data representing the user's desire can be input for each of the following periods: a wake period, a day period, an evening period, and a sleep period. Specifically, a boundary time between each period, a cooling set temperature and a heating set temperature in each period, and an air volume of the fan 138 in each period can be input for each day of the week. Such input can be performed using the input keys 82 to 85. When an external device 119 such as a personal computer or the like is connected to the control interface 111 as shown in FIG. 18, such input can be performed using an input function of the external device 119. In other words, the control interface 111 has a port for connecting the external device 119 such as a personal computer or the like thereto.

Next, control of each device based on the schedule information is described.

Based on the information regarding the cooling and heating set temperatures and the air volume of the fan 138, which are stored in the memory 112a, the scheduling unit 112b of the main controller 112 issues commands to the outdoor unit controller 113 of the heat pump, the gas furnace controller 115, and the fan 138, and activates the heat pump, the gas furnace 136, and the fan 138. Accordingly, for example, in a given day, air-conditioning control will be performed according to the schedule as shown in FIG. 9. Here, the air conditioning system is controlled such that cooling set temperature is 82 degrees F. and the heating set temperature is 61 degrees F. in the sleep period; the cooling set temperature is 77 degrees F. and the heating set temperature is 70 degrees F. in the wake period; the cooling set temperature is 86 degrees F. and the heating set temperature is 61 degrees F. in the day period, and the cooling set temperature is 77 degrees F. and the heating set temperature is 70 degrees F. in the evening period.

Note that, it is not only that the target air conditioning temperature is changed to the air conditioning set temperature which is set for a predetermined time based on the schedule information when the predetermined time comes, but here, preliminary control is performed such that the actual temperature in the building 101 has already reached the air conditioning set temperature which is set for a predetermined time when the predetermined times comes. The preliminary control is described later.

<Demand Control>

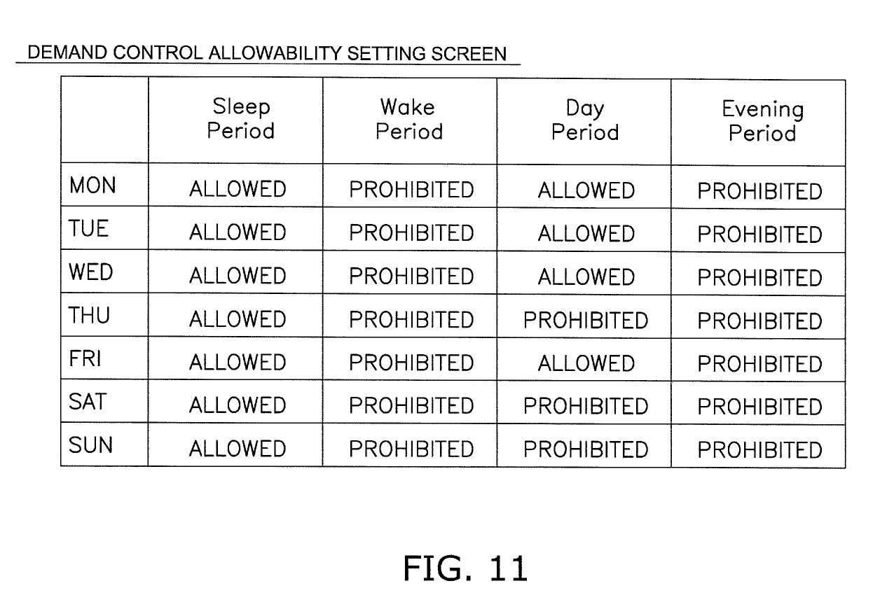

In addition, the main controller 112 has a map regarding the allowability of demand control in the memory 112a as shown in FIG. 11. Here, the user input is allowed through the control interface 111 based on a demand control allowability setting screen shown in FIG. 11, and the user can arbitrarily decide the allowability of the demand control in each period. However, the map regarding the allowability of demand control may be set by default to prohibit a change by the user or to place restrictions on a change by the user. By the default setting, the demand control is allowed in the day period during weekdays (from Monday to Friday) when a person is usually not home and the sleep period when a person is usually asleep. The demand control is prohibited in other periods and on the weekend (Saturday and Sunday).

Note that, the demand control is control in which the amount of electrical energy consumed by the heat pump is monitored on real-time to place restrictions on the capacity of the compressor 122 and to temporarily remove the target air conditioning temperature from the set temperature in order to prevent the energy consumption per predetermined unit time from exceeding the upper limit value. When the demand control is applied during cooling, the user in the building 101 may temporarily feel discomfort, however, often times there is no problem as long as it happens during the day period when a person is usually not home or the sleep period. In addition, when the demand control is applied during heating, the heating capacity by the heat pump temporarily will drop, however, there will be no particular problem because the main controller 112 sends a command to the gas furnace controller 115 to cause the gas furnace 136 to work to compensate the drop.

Through such demand control, energy conservation and cost reduction can be facilitated.

<Preliminary Control Based on the Schedule>

As described above, the scheduling unit 112b of the main controller 112 changes the target air conditioning temperature in each period based on the information on the cooling and heating set temperatures and the air volume of the fan 138, which are stored in the memory 112a. Further, in order to cause the temperature in the building 101 to reach the set temperature which is set for the next period prior at a boundary time between the current period and the next period, the scheduling unit 112b performs the preliminary control in which the target air conditioning temperature is changed to the set temperature which is set for the next period prior to the boundary time. In addition, the main controller 112 has a learning function, and adjusts the start time at which the target air conditioning temperature is changed in the preliminary control according to the state of the preliminary control in the past.

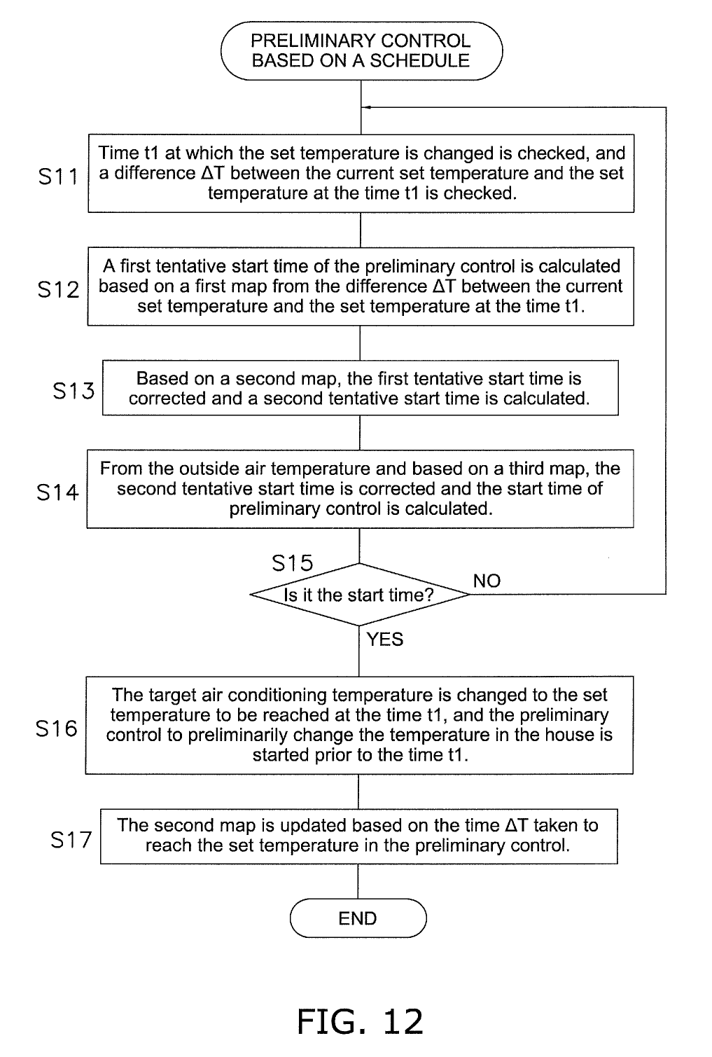

The preliminary control is described with reference to the control flow shown in FIG. 12.

In step S11, a boundary time (time at which the next period with a different set temperature starts) t1 at which the set temperature is changed is checked, and a temperature difference ΔT between the current set temperature and the set temperature which is set for the period after the boundary time t1 is determined.

Next, in step S12, a first tentative start time is calculated based on a first map (not shown) from the temperature difference ΔT between the current set temperature and the set temperature which is set for the period after the boundary time t1. The first map determines a correlation between the temperature difference ΔT and the amount of time moved ahead for both cooling and heating. For example, when the temperature difference is 5 degrees F. during cooling, the amount of time moved ahead is determined to 40 minutes. Time earlier than the boundary time t1 by this amount of time to be moved ahead is the first tentative start time.

Next, in step S13, a second tentative start time is calculated from the time Δt based on a second map (not shown). The second map is described later.

Next, in step S14, the start time of the preliminary control is calculated from the outside air temperature based on a third map (not shown). The third map determines a correction time to be added to the amount of time moved ahead which is determined by the first map, with respect to the relationship between the set temperature and the outside air temperature for both cooling and heating. For example, when the outside air temperature is significantly higher than the set temperature, the correction time on the third map is determined to be longer than when otherwise.

Next, in step S15, whether or not the current time has passed over the start time calculated in step S14 is judged. When the current time has not passed over the start time, the process returns to step S11, and steps S11 to S14 to determine the start time are performed again. When the current time has passed over the start time, the process proceeds to step S16 to start the preliminary control.

In the preliminary control in step S16, the target air conditioning temperature is changed to the set temperature which is set for the period after the boundary time t1, even though the boundary time t1 has not yet reached, so that the temperature in the building 101 such as a house or the like can, in advance, be brought closer to the set temperature which is set for the period after the boundary time t1.

Step S16 finishes when the temperature in the building 101 such as a house or the like reaches the set temperature which is set for the period after the boundary time t1, i.e., a new target air conditioning temperature. Then, in step S17, the time Δt taken from the start of the preliminary control in step S16 to the end of the preliminary control is written into the second map. The second map has a configuration that corresponds to the first map, and it is a map that determines a correction time to be added to the amount of time moved ahead which is determined by the first map. Specifically, the second map is a map by which the correction time is set for each temperature difference ΔT for both cooling and heating, and the default value of the correction time is zero. Thus, the second map is continuously updated, and the old value is overwritten and deleted by the new value.

Note that, needless to say, when the target air conditioning temperature is changed in the preliminary control, the main controller 112 will issue necessary commands to the outdoor unit controller 113 of the heat pump, the gas furnace controller 115, and the fan 138.

<Dehumidifying Operation>

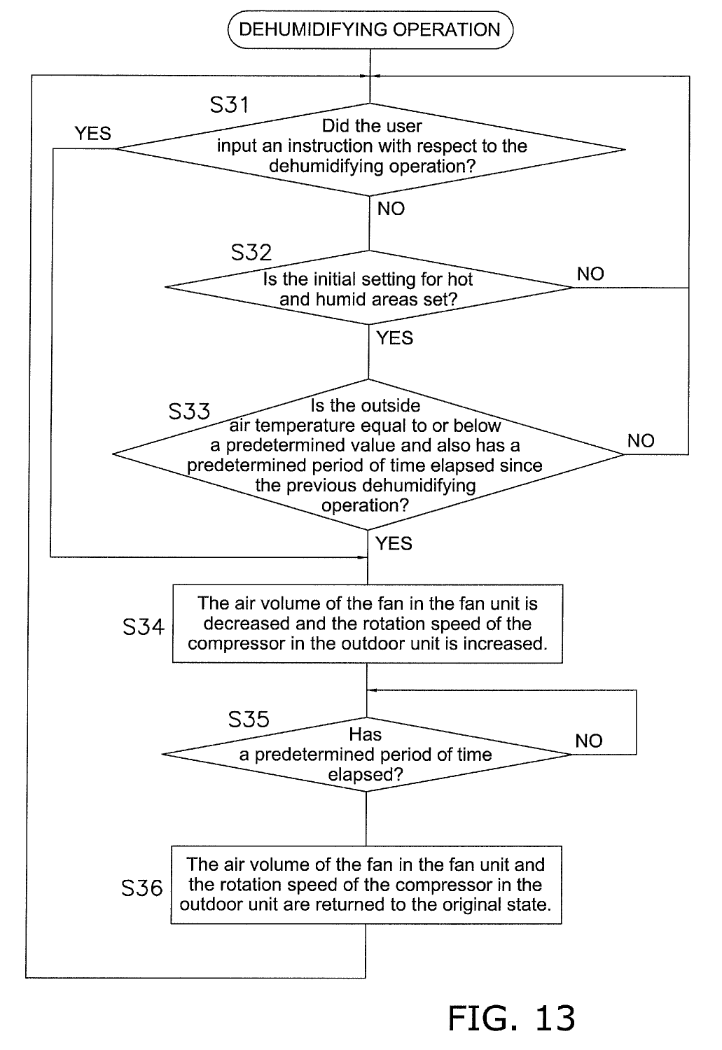

In this air conditioning system, as shown in the control flow shown in FIG. 13, a dehumidifying operation by the heat pump is performed. Below, the dehumidifying operation is described with reference to FIG. 13.

In step S31, whether or not an instruction with respect to the dehumidifying operation is input by the user is judged. The control interface 111 allows the user to input an instruction to start the dehumidifying operation. Specifically, the user can select to start the dehumidifying operation by pressing the input key 83 shown in FIG. 14 and opening the menu. When it is judged in step S31 that an instruction to start the dehumidifying operation is input, the process proceeds to step S34.

In step S32, whether or not the setting for hot and humid areas is set is judged. For example, in case of hot and humid areas such as Florida in the United States, the installation place being the hot and humid area is selected in the initial setting of the menu on the control interface 111. When it is judged in step S32 that the setting for hot and humid areas is set, next in step S33, whether or not the outside air temperature is equal to or below a predetermined value and also a predetermined period of time has elapsed since the previous dehumidifying operation is judged. When the conditions in both step S32 and step S33 are satisfied, the process proceeds to step S34.

In step S34, the dehumidifying operation is started. Specifically, the main controller 112 issues commands to the outdoor unit controller 113 of the heat pump and the fan 138 to decrease the air volume of the fan 138 and to increase the capacity of the compressor 122, causing the indoor heat exchanger 132 to condense and remove the moisture in the air in the building 101 and thus performing dehumidification.

This dehumidifying operation is continued until a predetermined period of time elapses. In step S35, when the predetermined period of time is judged to have elapsed, the process proceeds to step S36 where the air volume of the fan 138 and the capacity of the compressor 122 are returned to the original state and the operation mode is returned to the normal air conditioning operation.

<Display at the Time of the Failure of the Heat Pump and the Like>

The outdoor unit controller 113 of the heat pump has a fault detection function that detects a failure of the heat pump by a fault detection unit (fault detection program) 113b. Specifically, values of various sensors are constantly monitored, and when a sensor value during the operation and/or a numerical value calculated from the sensor value is beyond a predetermined range, a portion of failure and a failure state are specified, and information such as an error code is transmitted from the outdoor unit controller 113 to the main controller 112. For example, it is judged that the compressor 122 has a failure when a state continues in which the discharge refrigerant pressure remains the same even though the rotation speed of the compressor 122 is increased.

In addition, the gas furnace controller 115 has a similar fault detection function that transmits a failure message to the main controller 112 at the time of the failure of the gas furnace 136.

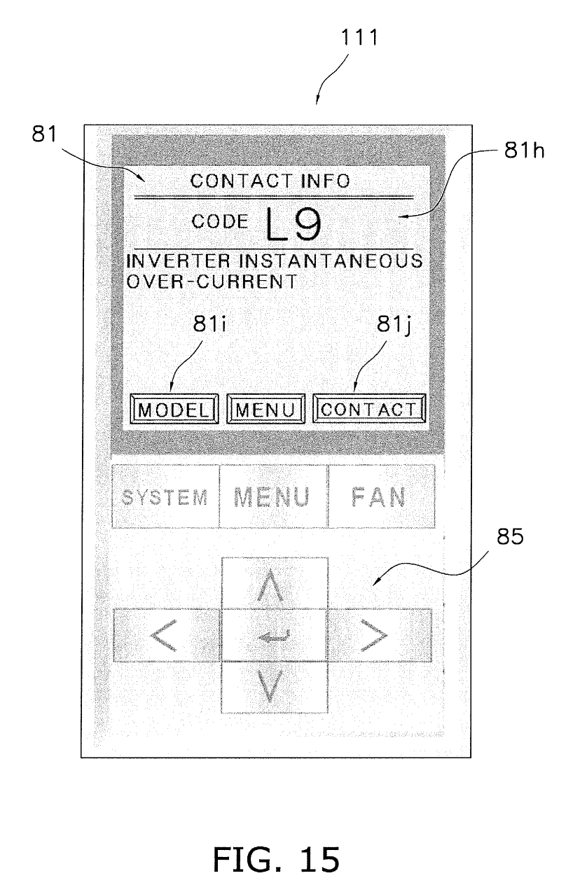

The main controller 112 is provided with the memory 112a that stores contact information (telephone number, mail address, and the like) in case of a failure of the heat pump and the like. When a failure signal is received, the main controller 112 causes the display 81 of the control interface 111 to display information indicating the failure. FIG. 15 shows an example of such display. In FIG. 15, information 81h of an error code (here, code L9) and information on the cause of the failure (here, instantaneous over current of the inverter) are displayed on the display 81.

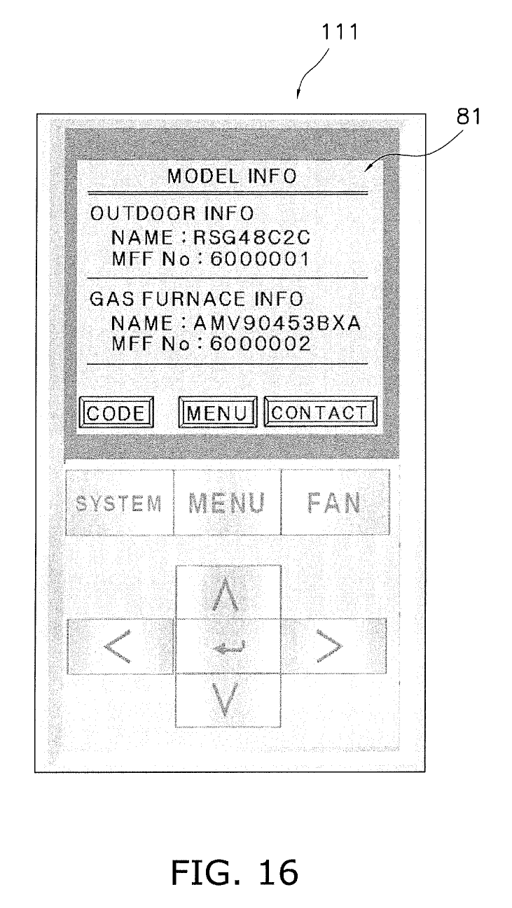

When information 81i for “MODEL” on the display 81 is selected using the input key 85 on the screen shown in FIG. 15, a screen shown in FIG. 16 appears, which displays the model names and serial numbers of the heat pump and the gas furnace 136.

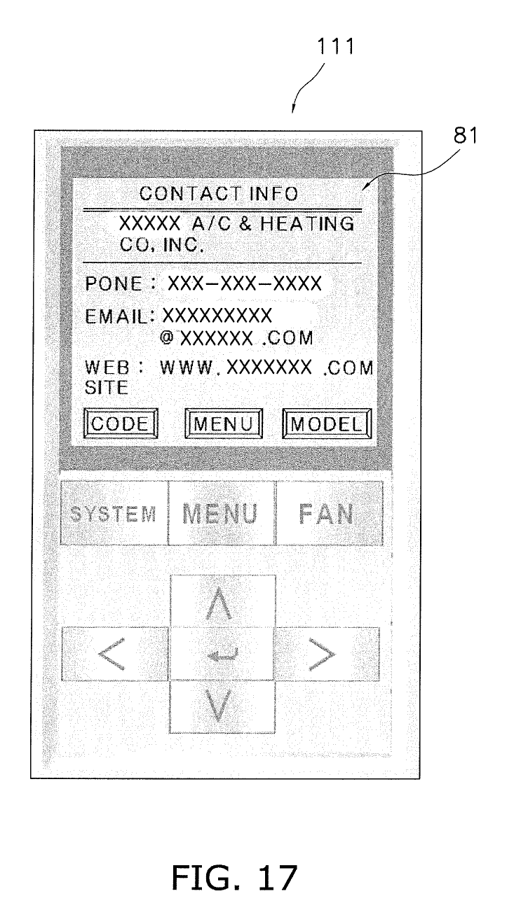

In addition, when information 81j for “CONTACT” on the display 81 is selected using the input key 85 on the screen shown in FIG. 15, a screen shown in FIG. 17 appears, which displays a telephone number, mail address, website address, and the like of a company that provides maintenance on the device in which a failure has occurred. This information is information stored in the memory 112a of the main controller 112.

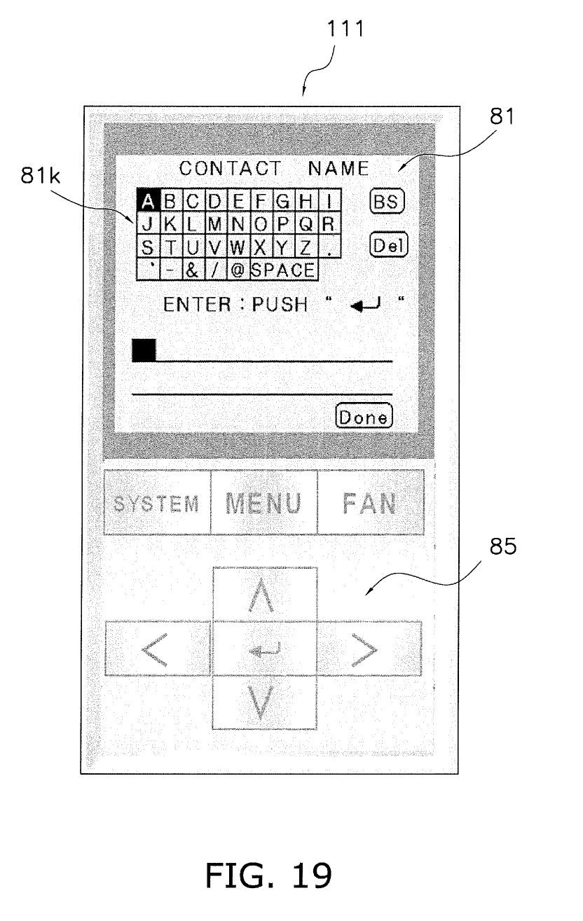

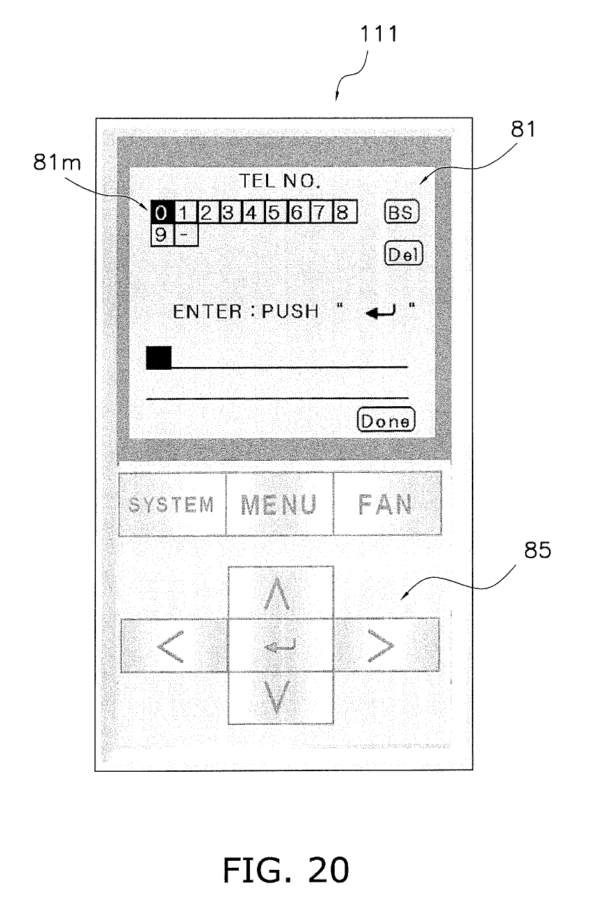

Note that the contact information of the memory 112a of the main controller 112 is manually input by an installation worker at the time of initial setting of the air conditioning system using the input key 85 of the control interface 111 or the external device 119 such as a personal computer or the like connected to the control interface 111. When input is performed using the input key 85, a cursor is moved to an input item on a screen shown in FIG. 18 to select the input item. Then, as shown in FIGS. 19 and 20, information 81k, i.e., keys of a keyboard, and information 81m, i.e., keys of a numeric keypad, appear on the display 81, which allows the user to input letters and numbers.

<CHARACTERISTICS OF THE AIR CONDITIONING SYSTEM ACCORDING TO THE SECOND EMBODIMENT>

(1)

In the air conditioning system according to the second embodiment, the configuration is employed in which the main controller 112 different from the control interface 111 is provided and two-way communication is performed between the main controller 112 and the outdoor unit controller 113 of the heat pump, unlike a conventional air conditioning system in which the control interface is equipped with a control function for the entire air conditioning system. Thus, the main controller 112 can obtain data concerning the operation state and the like of the heat pump and perform various types of finely-tuned control with respect to the heat pump and the gas furnace 136.

(2)

Unlike a conventional air conditioning system that is configured to simply determine whether to activate the heat pump or the gas furnace 136 based on the outside air temperature and the like, the air conditioning system according to the second embodiment is configured such that the main controller 112 performs the efficiency priority control that preferentially activates whichever will have a higher efficiency, according to the operation state of the heat pump. Thus, the total energy consumption can be reduced compared with the conventional system.

(3)

In the air conditioning system according to the second embodiment, the user can select that the demand control be performed during a predetermined day and period and that the demand control be not performed outside the predetermined day and period (see FIG. 11). Accordingly, the demand control is allowed to be performed during when the discomfort does not increase so much even if the demand control is performed and thereby it is possible to maintain inside the building 101 to be a comfortable space for the user while facilitating energy conservation and a reduction in the cost of energy consumed by the air conditioning system.

(4)

In the conventional air conditioning system, the dehumidifying operation is automatically performed when it is determined to be highly humid based on a detection result by a humidity sensor and the like. However, in the air conditioning system according to the second embodiment, because the dehumidification control is performed when an instruction to start the dehumidifying operation is input through the control interface 111 (see FIG. 13), an improper reduction in the comfort level of the user in the building 101 is prevented.

(5)

In addition, as shown in the control flow in FIG. 13, when the setting for hot and humid areas is set, the main controller 112 regularly performs the dehumidifying operation when the outside air temperature drops, so that efficient dehumidification can be achieved.

(6)

In the air conditioning system according to the second embodiment, during the dehumidifying operation, the air volume of the fan 138 is decreased and the capacity of the compressor 122 is increased, so that it is possible to ensure the amount of dehumidification while reducing the discomfort of the user in the building 101 because of a sudden drop in the temperature.

(7)

In the air conditioning system according to the second embodiment, the start time of the preliminary control according to the schedule is corrected using the second map that reflects the state of the preliminary control in the past. Thus, unlike a conventional air conditioning system, the probability where the temperature in the building 101 has basically reached the set temperature at the beginning of the next period in the schedule will be higher.

(8)

In the air conditioning system according to the second embodiment, during the normal operation, the outside air temperature measured by the outside air temperature sensor 127 of the heat pump is displayed (see FIG. 14) on the display 81 of the control interface 111, so that in the case such as when the current temperature is slightly inconsistent with the set temperature, the user can judge whether or not it is affected by the outside air temperature.

(9)

In the air conditioning system according to the second embodiment, when a failure occurs in the heat pump and the like, the contact information can be easily displayed on the display 81 of the control interface 111 (see FIGS. 15 and 17). Thus, the user can save the labor of searching for the contact information and can also contact the contact information that is definitely correct.

### ALTERNATIVE EMBODIMENT OF THE SECOND EMBODIMENT

(A)

In the air conditioning system of the above described second embodiment, the gas furnace unit 135 having the gas furnace 136 is employed as the heating device other than the heat pump; however, an electrical heater that generates heat from electrical energy may be employed instead of the gas furnace unit 135.

(B)

In the above described second embodiment, the air conditioning system is constituted by the heat pump, the gas furnace unit 135, and the fan unit 137, however, it is possible to add other devices such as a humidification unit, a ventilation unit (ventilator) equipped with a heat exchange function, a dust collection unit including a filter and the like, a zone damper inserted into a duct 151, and the like.

(C)

In the air conditioning system of the above described second embodiment, the main controller 112 performs the efficiency priority control, however, the main controller 112 can be caused to perform cost priority control instead of the efficiency priority control.

In the cost priority control, the cost of electrical energy consumed per unit time by the heat pump and the cost of gas energy consumed per unit time by the gas furnace 136, which are required to perform the same level of the hating capacity, are compared with each other in order to adjust the capacity of the compressor 122 and the combustion level of the gas furnace 136 such that the total energy cost is reduced according to the operation state of the heat pump; and commands are issued to the outdoor unit controller 113 and the gas furnace controller 115.

(D)

In the air conditioning system of the above described second embodiment, the input keys 82 to 85 of the control interface 111 and the external device 119 (see FIG. 18) connected to the control interface 111 are described as the means with which the user performs input operation using the control interface 111, however, a different inputting means can be provided. For example, a recording medium such as a memory card or the like may be incorporated in the control interface 111 so as to use such memory card or the like as an inputting means.

(E)

In the air conditioning system of the above described second embodiment, the main controller 112 is housed inside the gas furnace unit 135; however, the main controller 112 may be arranged inside the indoor heat pump unit 131, inside the fan unit 137, or outside the indoor unit 130.

1. An air conditioning system, comprising:
a first heat exchanging device configured to cause heat exchange between surrounding air and refrigerant flowing thereinside;
a fan configured to send the air cooled or heated by at least the first heat exchanging device to a plurality of rooms in a house via a duct;
a capacity controllable compressor installed outside the house;
a second heat exchanging device installed outside the house that is configured to cause heat exchange between air outside the house and the refrigerant; and
a control unit configured to control the capacity of the capacity controllable compressor,
the first heat exchanger, the capacity controllable compressor and the second heat exchanger together forming a heat pump.

2. The air conditioning system according to claim 1, wherein
the capacity controllable compressor compresses the refrigerant using driving force of an electric motor, which has rotation speed changed by inverter control, and
the control unit controls the inverter for the capacity controllable compressor.

3. The air conditioning system according to claim 1, wherein
the first heat exchanging device includes a plurality of heat exchangers, the air conditioning system further comprises
a plurality of valves that adjust an amount of refrigerant flowing through each of the heat exchangers of the first heat exchanging device, and
the control unit further controls the plurality of valves to adjust the amount of refrigerant flowing through each of the heat exchangers of the first heat exchanging device.

4. The air conditioning system according to claim 3, further comprising
a damper connected to the plurality of heat exchangers of the first heat exchanging device, the damper being configured to adjust the amount of the air flowing in the surrounding of the heat exchangers, wherein
the control unit further controlling the damper.

5. The air conditioning system according to claim 3, wherein
the fan is connected to each of the heat exchangers of the first heat exchanging device.
to each of the plurality of heat exchangers of

6. An air conditioning system that supplies conditioned air to a room in a house via a duct, comprising:
a heat pump configured to cool air sent to the duct in a cooling mode and configured to heat air sent to the duct in a heating mode;
a heating device separate from the heat pump, the heating device being configured to heat air sent to the duct; and
a control unit configured to adjust a level of air cooling by the heat pump in the cooling mode, configured to adjust a level of air heating by the heat pump in the heating mode, and configured to adjust a level of air heating by the heating device in accordance with an operation state of the heat pump.

7. An air conditioning system according to claim 6, wherein
the control unit is configured to perform efficiency priority control in which energy consumption efficiency of the heat pump is compared with energy consumption efficiency of the heating device in order to adjust the levels of air cooling and air heating in accordance with the operation state of the heat pump.

8. The air conditioning system according to claim 6, wherein
the control unit is configured to perform cost priority control in which cost of energy consumed per unit time by the heat pump is compared with cost of energy consumed per unit time by the heating device in order to adjust the levels of air cooling and air heating in accordance with the operation state of the heat pump.

9. The air conditioning system according to claim 6, wherein the heating device performs heating by combustion.

10. The air conditioning system according to claim 6, wherein the heating device is an electrical heater.

11. An air conditioning system, comprising:
a first heat exchanging device configured to cause heat exchange between surrounding air and refrigerant flowing thereinside;
a capacity controllable compressor installed outside a house;
a second heat exchanging device installed outside the house that is configured to cause heat exchange between air outside the house and the refrigerant, the first heat exchanger, the capacity controllable compressor and the second heat exchanger together forming a heat pump;
a heat pump control unit configured to control the capacity of the capacity controllable compressor;
a control interface configured to allow input of a set temperature in the house; and
a system control unit directly or indirectly electrically connected to the heat pump control unit and the control interface, the system control being configured to perform two-way communication with the heat pump control and being configured to issue a command to at least a device other than the heat pump.

12. The air conditioning system according to claim 11, wherein
the device other than the heat pump is at least one of a heating device that performs heating by combustion, an electrical heater, a fan that sends conditioned air to a plurality of rooms in a house, a humidifier, a total heat exchanger, and a sensible heat exchanger.

13. The air conditioning system according to claim 11, wherein
the system control unit is configured to issue a command to the device other than the heat pump and the heat pump.

14. An air conditioning system, comprising:
a set temperature scheduling unit configured to change set temperature for air conditioning in a house for at least two different time periods;
an air conditioning unit configured to perform air conditioning in the house using energy; and
a control unit configured to control the air conditioning unit giving priority to the set temperature during a predetermined one of the time periods demarcated by the set temperature scheduling unit, and configured to control the air conditioning unit giving priority to keeping energy consumption per unit time below a predetermined upper limit when outside the predetermined one of the time periods.

15. The air conditioning system according to claim 14, wherein
the predetermined one of the time periods is at least one of during weekdays when a person is usually not home and when a person is usually asleep.

16. An air conditioning system that supplies conditioned air to a room in a house via a duct, comprising:
a heat pump configured to cool air sent to the duct in a cooling mode and configured to heat air sent to the duct in a heating mode;
a fan configured to send the conditioned air cooled or heated by the heat pump to a room in a house via the duct,
a control interface configured to allow input of an instruction with respect to a dehumidifying operation; and
a control unit configured to perform dehumidification control in which the conditioned air is dehumidified by controlling at least one of the heat pump and the fan when the instruction with respect to the dehumidifying operation is input to the control interface.

17. An air conditioning system that supplies conditioned air to a room in a house via a duct, comprising:
a heat pump configured to cool air sent to the duct in a cooling mode and configured to heat air sent to the duct in a heating mode;
a fan configured to send the conditioned air cooled or heated by the heat pump to a room in a house via the duct;
an outside air temperature sensor configured to measure an outside air temperature outside the house; and
a control unit configured to periodically perform periodic dehumidification control in which the conditioned air is dehumidified by controlling at least one of the heat pump and the fan when the outside air temperature measured by the outside air temperature sensor falls below a predetermined value.

18. An air conditioning system that supplies conditioned air to a room in a house via a duct), comprising:
a heat pump having a capacity controllable compressor, the heat pump being configured to cool air sent to the duct in a cooling mode and configured to heat air sent to the duct in a heating mode;
a fan configured to send the conditioned air cooled or heated by the heat pump to a room in a house via the duct, the fan being configured to send an adjustable air volume to the room in the house via the duct; and
a dehumidification control unit configured to decrease air volume of the fan and increase capacity of the compressor during a dehumidifying operation.

19. An air conditioning system that supplies conditioned air to a room in a house, comprising:
a heat pump configured to cool air sent to the room in the house in a cooling mode and configured to heat air sent to the room in the house in a heating mode;
a control interface configured to allow input of a set temperature to be reached at a predetermined time in the room in the house;
a control unit configured to perform preliminary control in which a target air conditioning temperature is changed to the set temperature prior to the predetermined time such that the set temperature is approached in the room in the house by the predetermined time; and
a learning and improving unit configured to adjust start time at which the target air conditioning temperature is changed to the set temperature in a subsequent preliminary control based on the prior preliminary control.

20. The air conditioning system according to claim 19 further comprising
a heating device other than the heat pump that is configured to heat air sent to the room in the house, wherein
the control unit issues a command to the heating device in addition to the heat pump when performing the preliminary control.

21. The air conditioning system according to claim 19, further comprising
an outside air temperature sensor configured to measure an outside air temperature outside the house, wherein
the learning and improving unit adjusts the start time based on the outside air temperature.

22. An air conditioning system that supplies conditioned air to a room in a house via a duct, comprising:
a first heat exchanging device configured to cause heat exchange between surrounding air and refrigerant flowing thereinside;
a capacity controllable compressor installed outside the house;
a second heat exchanging device installed outside the house that is configured to cause heat exchange between air outside the house and the refrigerant, the first heat exchanger, the capacity controllable compressor and the second heat exchanger together forming a heat pump;
a heat pump control unit configured to control the capacity of the capacity controllable compressor;
an outside air temperature sensor configured to measure an outside air temperature outside the house and send the outside air temperature to the heat pump control unit; and
an control interface directly or indirectly connected to the heat pump control unit,
the control interface having an input unit configured to allow input of a set temperature in the house and a display unit configured to display the outside air temperature.

23. An air conditioning system that supplies conditioned air to a room in a house via a duct, comprising:
a heat pump configured to cool air sent to the duct in a cooling mode and configured to heat air sent to the duct in a heating mode;
a control interface having a display device, and further either having an inputting device configured to allow input of a set temperature in the house or being capable of connecting the inputting device thereto;
a heat pump control unit configured to control the heat pump based on the set temperature;
a fault detection unit configured to detect a fault in the heat pump; a contact information storage unit configured to store contact information in case of a failure of the heat pump; and
a contact information display unit configured to display the contact information stored in the contact information storage unit on the display device of the control interface when a failure of the heat pump is detected by the fault detection unit.

24. The air conditioning system according to claim 23, wherein
the inputting device is any one of a computer having an input function connected to the control interface, an input-only device connected to the control interface, and a read-out device of a recording medium incorporated in the control interface or in the device connected to the control interface.

25. The air conditioning system according to claim 24, further comprising
a set temperature scheduling unit incorporated in or connected to the control interface and configured to change a set temperature for air conditioning in a house for at least two different time periods, wherein
the inputting device is configured to allow input for setting the set temperature for the at least two different time periods.
